(19) United States
(12) Patent Application Publication
(10) Pub. No.: US 2016/0320894 A1
(43) Pub. Date: Nov. 3, 2016

(54) TOUCH DISPLAY PANEL AND TOUCH DISPLAY DEVICE

(71) Applicant: SHENZHEN CHINA STAR OPTOELECTRONICS TECHNOLOGY CO., LTD., Guangdong (CN)

(72) Inventors: Yucheng Lu, Guangdong (CN); Xiang Yang, Guangdong (CN); Chun-Hung Huang, Guangdong (CN)

(21) Appl. No.: 14/417,113

(22) PCT Filed: Dec. 30, 2014
(86) PCT No.: PCT/CN2014/095539

§ 371 Date: Jan. 23, 2015

(30) Foreign Application Priority Data
Dec. 22, 2014 (CN) 201410804918.1

(51) Int. Cl. G06F 3/041; G02F 1/1335; G02F 1/1345; G02F 1/1333

(52) U.S. Cl. CPC G06F 3/0416; G06F 3/0412; G02F 1/13338; G02F 1/133514; G02F 1/13452; G02F 2201/121

(57) ABSTRACT

A touch display panel is provided. It includes a color filter substrate, an array substrate, a liquid-crystal layer, and a driver chip. The color filter substrate has a plurality of common electrodes disposed thereon; the array substrate has a plurality of pixel electrodes disposed thereon 221. The driver chip is coupled to the common electrodes via driving wires. The driver chip provides common voltage signals with a plurality of different amplitudes. The present invention makes the differences between the amplitudes of the common voltage signals after attenuation smaller by providing the common voltage signals with the different amplitudes, thereby avoiding a technical problem of flicker.

### TECHNICAL FIELD OF THE INVENTION

The present invention relates to a touch technology, and in particular to a touch display panel and a touch display device.

### BACKGROUND OF THE INVENTION

With development in display technologies, touch panels of touch display devices are mounted on display panels by using an in-cell manner. This can greatly reduce light transmittance of the touch display devices.

The conventional touch display device employs common electrodes on the display panel to utilize as sensing electrodes for achieving induction of touch signals. The specific structure is shown in FIG. 1, which is a schematic drawing illustrating the sensing electrodes of a prior art touch display panel. When the touch display panel 10 is in a touch mode, each of the sensing electrodes 11 in this drawing is coupled to a driver chip 13 via a sensing wire 12. When touch display panel 10 is in a display mode, the driver chip 13 shorts all the sensing wires 12, and the sensing wires 12 provide all the sensing electrodes 11 with an identical common voltage.

However, in using the prior art touch display panel, lengths of the sensing wires 12 that respectively correspond to every sensing electrode 11 are different. Accordingly, when the touch display panel 10 is in the display mode, since RC impedances of the different sensing wires 12 are different, degrees of attenuation in the common voltage on every sensing electrodes 11 are different, such that the touch display panel 10 is prone to generate a technical problem of flicker in displaying.

Therefore, there is a significant need to provide a touch display panel and a touch display device for solving the problem existing in the prior art.

### SUMMARY OF THE INVENTION

An objective of the present invention is to provide a touch display panel and a touch display device with smaller differences between amplitudes of common voltage signals of respective common electrodes, thereby solving the technical problem that the amplitudes of the common voltage signals in the conventional touch display panel and touch display device are larger such that flicker occurs on the touch display panel.

To achieve the foregoing objective, the technical solution of this invention is implemented as follows.

an embodiment of the present invention provides a touch display panel, which includes:

a color filter substrate having a plurality of common electrodes disposed thereon;

an array substrate having a plurality of pixel electrodes disposed thereon; a liquid-crystal layer disposed between the color filter substrate and the array substrate; and

a driver chip coupled to the common electrodes via driving wires, utilized to provide common voltage signals or touch driving signals for the common electrodes, wherein the driving wires are in one-to-one correspondence with the common electrodes;

wherein the driver chip provides the common voltage signals with a plurality of different amplitudes;

wherein when the touch display panel is in a touch mode, the common electrodes on the color filter substrate receive the touch driving signal of the driver chip; when the touch display panel is in a display mode, the common electrodes on the color filter substrate receive the common electrode signal of the driver chip.

In the touch display panel of the present invention, the driver chip sets the corresponding amplitudes of the common voltage signals in accordance with lengths of the driving wires.

In the touch display panel of the present invention, the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

In the touch display panel of the present invention, differences between the amplitudes of the common voltage signals after attenuation received by the different common electrodes are smaller than a set value.

In the touch display panel of the present invention, the driver chip obtains the common voltage signals with the plurality of different amplitudes from a specific storage by a look-up table manner.

An embodiment of the present invention provides a touch display panel, which includes:

a color filter substrate having a plurality of common electrodes disposed thereon;

an array substrate having a plurality of pixel electrodes disposed thereon; a liquid-crystal layer disposed between the color filter substrate and the array substrate; and

a driver chip coupled to the common electrodes via driving wires, utilized to provide common voltage signals or touch driving signals for the common electrodes, wherein the driving wires are in one-to-one correspondence with the common electrodes;

wherein the driver chip provides the common voltage signals with a plurality of different amplitudes.

In the touch display panel of the present invention, when the touch display panel is in a touch mode, the common electrodes on the color filter substrate receive the touch driving signal of the driver chip.

In the touch display panel of the present invention, when the touch display panel is in a display mode, the common electrodes on the color filter substrate receive the common electrode signal of the driver chip.

In the touch display panel of the present invention, the driver chip sets the corresponding amplitudes of the common voltage signals in accordance with lengths of the driving wires.

In the touch display panel of the present invention, the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

In the touch display panel of the present invention, differences between the amplitudes of the common voltage signals after attenuation received by the different common electrodes are smaller than a set value.

In the touch display panel of the present invention, the driver chip obtains the common voltage signals with the plurality of different amplitudes from a specific storage by a look-up table manner.

An embodiment of the present invention further provides a touch display device, which includes a backlight source and a touch display panel. The touch display panel includes:

a color filter substrate having a plurality of common electrodes disposed thereon;

an array substrate having a plurality of pixel electrodes disposed thereon;

a liquid-crystal layer disposed between the color filter substrate and the array substrate; and

a driver chip coupled to the common electrodes via driving wires, utilized to provide common voltage signals or touch driving signals for the common electrodes, wherein the driving wires are in one-to-one correspondence with the common electrodes;

wherein the driver chip provides the common voltage signals with a plurality of different amplitudes.

In the touch display device of the present invention, when the touch display panel is in a touch mode, the common electrodes on the color filter substrate receive the touch driving signal of the driver chip.

In the touch display device of the present invention, when the touch display panel is in a display mode, the common electrodes on the color filter substrate receive the common electrode signal of the driver chip.

In the touch display device of the present invention, the driver chip sets the corresponding amplitudes of the common voltage signals in accordance with lengths of the driving wires.

In the touch display device of the present invention, the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

In the touch display device of the present invention, differences between the amplitudes of the common voltage signals after attenuation received by the different common electrodes are smaller than a set value.

In the touch display device of the present invention, the driver chip obtains the common voltage signals with the plurality of different amplitudes from a specific storage by a look-up table manner.

In comparison with the prior art touch display panel and touch display device, the touch display panel and the touch display device of the present invention makes the differences between the amplitudes of the attenuated common voltage signals smaller by providing the common voltage signals with the different amplitudes. The invention solves the technical problem that the amplitudes of the common voltage signals in the conventional touch display panel and touch display device are larger such that flicker occurs on the touch display panel.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating sensing electrodes of a prior art touch display panel;

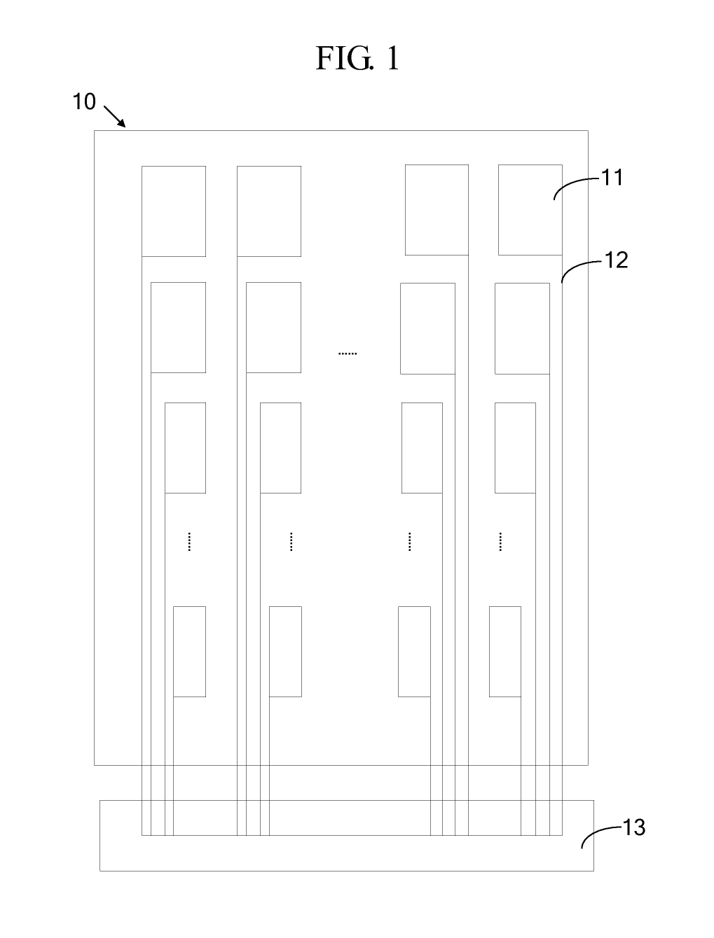

FIG. 2 is a schematic drawing illustrating a touch display panel according to a preferred embodiment of the present invention;

FIG. 3 is a cross-sectional view along a section line A-A′ of FIG. 2; and

FIG. 4 is a comparison diagram illustrating common voltage signals provided by a driver chip and common voltage signals received by common electrodes.

### DETAILED DESCRIPTION OF THE INVENTION

Descriptions of the following embodiments refer to attached drawings which are utilized to exemplify specific embodiments. Directional terms mentioned in the present invention, such as “top” and “down”, “front”, “rear”, “left”, “right”, “inside”, “outside”, “side” and so on are only directions with respect to the attached drawings. Therefore, the used directional terms are utilized to explain and understand the present invention but not to limit the present invention.

In different drawings, the same reference numerals refer to like parts throughout the drawings.

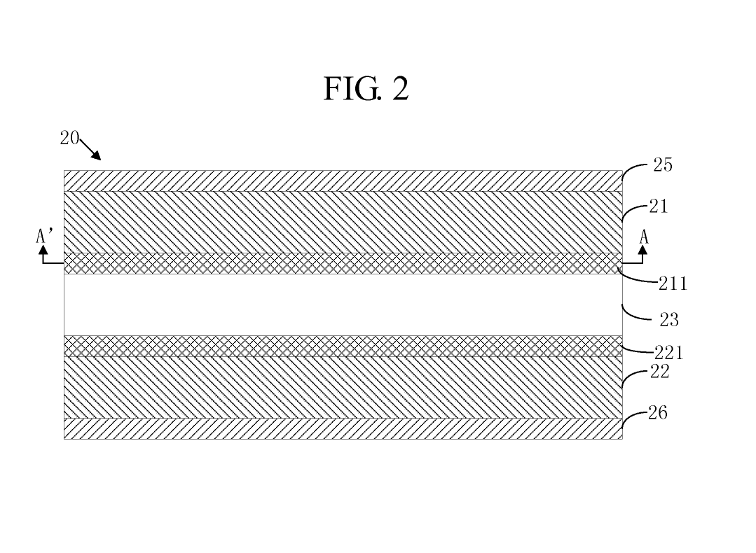

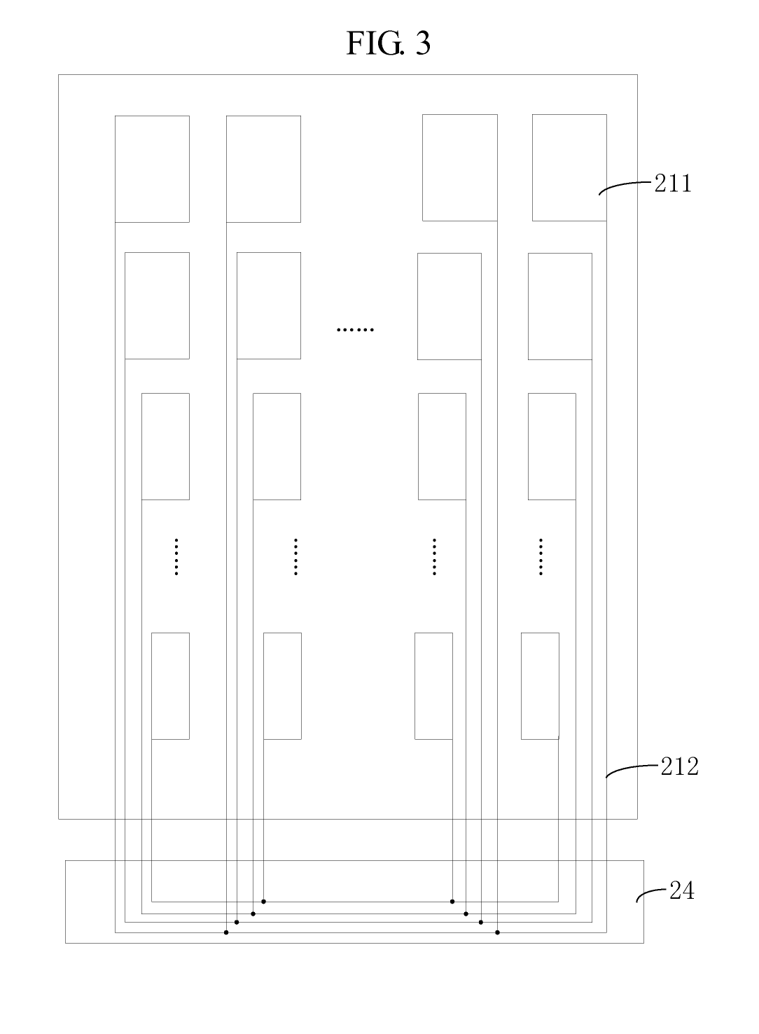

Referring to FIG. 2 and FIG. 3, FIG. 2 is a schematic drawing illustrating a touch display panel according to a preferred embodiment of the present invention; FIG. 3 is a cross-sectional view along a section line A-A′ of FIG. 2. The touch display panel 20 of the preferred embodiment includes a color filter substrate 21, an array substrate 22, a liquid-crystal layer 23, a driver chip 24, a first polarizer 25, and a second polarizer 26. The color filter substrate 21 has a plurality of common electrodes 211 disposed thereon; the array substrate 22 has a plurality of pixel electrodes 221 disposed thereon 221. The liquid-crystal layer 23 is disposed between the color filter substrate 21 and the array substrate 22. The driver chip 24 is coupled to the common electrodes 211 via driving wires 212 and utilized to provide common voltage signals or touch driving signals for the common electrodes 211. The driving wires 212 herein are in one-to-one correspondence with the common electrodes 211.

In one preferred embodiment, the driver chip 24 provides the common voltage signals with a plurality of different amplitudes, and the driver chip 24 can set the amplitudes of the common voltage signals corresponding to the common electrodes 211 in accordance with lengths of the driving wires 212.

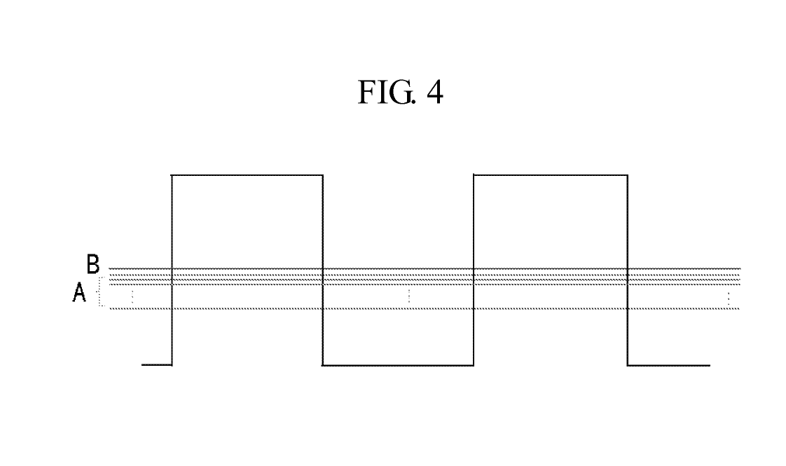

Assume that a first common voltage signal is provided to the corresponding common electrode via a first driving wire, and second common voltage signal is provided to the corresponding common electrode via a second driving wire. If the length of the first driving wire is larger than the length of the second driving wire; that is, a RC impedance of first driving wire is larger than that of the second driving wire, the amplitude of the first common voltage signal provided by the driver chip 24 is larger than the amplitude of the second common voltage signal provided by the driver chip 24. This enables a difference between the amplitude of the first common voltage signal attenuated by the first driving wire and the amplitude of the second common voltage signal attenuated by the second driving wire to be smaller than a set value. Specifically, as shown in FIG. 4, part A of FIG. 4 indicates the common voltage signals with the plurality of different amplitudes provided by driver chip, and part B of FIG. 4 indicates the common voltage signals received by the common electrodes. It can be seen from the drawing that the differences between the common voltage signals received by the common electrodes have been smaller, thereby avoiding the problem of the differences between the amplitudes of the common voltage signals being too large and then avoiding the problem that flicker occurs on the touch display panel.

Preferably, the driver chip 24 can obtain the common voltage signals with the plurality of different amplitudes by the following steps:

I, the driver chip 24 provides the common voltage signals with a uniform amplitude for all the common electrodes 211 and then detects flicker values of respective image regions of the common electrodes of the touch display panel 20.

II, in accordance with the flicker values of the touch display panel 20, the amplitudes of the common voltage signals of the respective common electrodes 211 are adjusted, so that the flicker values of the respective image regions are all smaller than the set value.

III, the adjusted amplitudes of the common voltage signals and numbers of the corresponding driving wires 212 are stored into a specific storage.

Accordingly, while the touch display panel 20 carries out the display, the driver chip 24 can obtain the common voltage signals with the plurality of different amplitudes from the specific storage by a look-up table manner.

When touch display panel 20 of the preferred embodiment is in the touch mode, the common electrodes 211 on the color filter substrate 21 receives the touch driving signals of the driver chip 24, thereby being able to sense the touch operations on the surface of the touch display panel 20. When touch display panel 20 of the preferred embodiment is in the display mode, the common electrodes 211 on the color filter substrate 21 receive the common electrode signals of the driver chips 24. An interaction of the common electrode signals and data signals of the pixel electrodes 221 realizes twisting operation of liquid-crystal molecules within the liquid-crystal layer 23, thereby achieving the displaying operation of the touch display panel 20.

The touch display panel of the present invention makes the differences between the amplitudes of the attenuated common voltage signals smaller by providing the common voltage signals with the different amplitudes.

The embodiment of the present invention further provides a touch display device. The touch display device includes a backlight source and a touch display panel. The touch display panel includes a color filter substrate, an array substrate, a liquid-crystal layer, and a driver chip. The color filter substrate has a plurality of common electrodes disposed thereon; the array substrate has a plurality of pixel electrodes disposed thereon 221. The liquid-crystal layer is disposed between the color filter substrate and the array substrate. The driver chip is coupled to the common electrodes via driving wires and utilized to provide common voltage signals or touch driving signals for the common electrodes. The driving wires herein are in one-to-one correspondence with the common electrodes.

In one preferred embodiment, the driver chip provides the common voltage signals with a plurality of different amplitudes, and the driver chip can set the amplitudes of the common voltage signals corresponding to the common electrodes in accordance with the lengths of the driving wires.

Preferably, the driving wires includes a first driving wire and a second driving wire, and if the length of the first driving wire is larger than the length of the second driving wire, the amplitude of a first common voltage signal provided by the driver chip is larger than the amplitude of a second common voltage signal provided by the driver chip. The first common voltage signal herein is provided to the corresponding common electrode via the first driving wire. The second common voltage signal is provided to the corresponding common electrode via the second driving wire.

Preferably, the differences between the common voltage signals after attenuation received by the different common electrodes are smaller than a set value.

Preferably, the driver chip obtains the common voltage signals with the plurality of different amplitudes from a specific storage by a look-up table manner.

The touch display panel and touch display device of the present invention solve the technical problem that the flicker occurs on the touch display panel through improving the common voltage signal of the common electrodes. In one preferred embodiment, the common electrodes are disposed on the color filter substrate. However, it is easy to dispose the same or like common electrode structure on the array substrate by the person skilled in the art. Therefore, the touch display panel and the touch display device that have the common electrodes with different disposed locations are within the scope of the present invention.

The touch display panel and the touch display device of the present invention make the differences between the amplitudes of the attenuated common voltage signals smaller by providing the common voltage signals having the different amplitudes. The invention solves the technical problem that the amplitudes of the common voltage signals in the conventional touch display panel and touch display device are larger such that flicker occurs on the touch display panel.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims

What is claimed is:

1. A touch display panel comprising:
a color filter substrate having a plurality of common electrodes disposed thereon;
an array substrate having a plurality of pixel electrodes disposed thereon;
a liquid-crystal layer disposed between the color filter substrate and the array substrate; and
a driver chip coupled to the common electrodes via driving wires, utilized to provide common voltage signals or touch driving signals for the common electrodes, wherein the driving wires are in one-to-one correspondence with the common electrodes;
wherein the driver chip provides the common voltage signals with a plurality of different amplitudes;
wherein when the touch display panel is in a touch mode, the common electrodes on the color filter substrate receive the touch driving signal of the driver chip; when the touch display panel is in a display mode, the common electrodes on the color filter substrate receive the common electrode signal of the driver chip.

2. The touch display panel according to claim 1, wherein the driver chip sets the corresponding amplitudes of the common voltage signals in accordance with lengths of the driving wires.

3. The touch display panel according to claim 2, wherein the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

4. The touch display panel according to claim 1, wherein differences between the amplitudes of the common voltage signals after attenuation received by the different common electrodes are smaller than a set value.

5. The touch display panel according to claim 1, wherein the driver chip obtains the common voltage signals with the plurality of different amplitudes from a specific storage by a look-up table manner.

6. A touch display panel comprising:
a color filter substrate having a plurality of common electrodes disposed thereon;
an array substrate having a plurality of pixel electrodes disposed thereon;
a liquid-crystal layer disposed between the color filter substrate and the array substrate; and
a driver chip coupled to the common electrodes via driving wires, utilized to provide common voltage signals or touch driving signals for the common electrodes, wherein the driving wires are in one-to-one correspondence with the common electrodes;
wherein the driver chip provides the common voltage signals with a plurality of different amplitudes.

7. The touch display panel according to claim 6, wherein when the touch display panel is in a touch mode, and the common electrodes on the color filter substrate receive the touch driving signal of the driver chip.

8. The touch display panel according to claim 6, wherein when the touch display panel is in a display mode, and the common electrodes on the color filter substrate receive the common electrode signal of the driver chip.

9. The touch display panel according to claim 6, wherein the driver chip sets the corresponding amplitudes of the common voltage signals in accordance with lengths of the driving wires.

10. The touch display panel according to claim 9, wherein the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

11. The touch display panel according to claim 6, wherein differences between the amplitudes of the common voltage signals after attenuation received by the different common electrodes are smaller than a set value.

12. The touch display panel according to claim 6, wherein the driver chip obtains the common voltage signals with the plurality of different amplitudes from a specific storage by a look-up table manner.

13. A touch display device, comprising a backlight source and a touch display panel, the touch display panel comprising:
a color filter substrate having a plurality of common electrodes disposed thereon;
an array substrate having a plurality of pixel electrodes disposed thereon;
a liquid-crystal layer disposed between the color filter substrate and the array substrate; and
a driver chip coupled to the common electrodes via driving wires, utilized to provide common voltage signals or touch driving signals for the common electrodes, wherein the driving wires are in one-to-one correspondence with the common electrodes;
wherein the driver chip provides the common voltage signals with a plurality of different amplitudes.

14. The touch display device according to claim 13, wherein when the touch display panel is in a touch mode, the common electrodes on the color filter substrate receive the touch driving signal of the driver chip.

15. The touch display device according to claim 13, wherein when the touch display panel is in a display mode, the common electrodes on the color filter substrate receive the common electrode signal of the driver chip.

16. The touch display device according to claim 13, wherein the driver chip sets the corresponding amplitudes of the common voltage signals in accordance with lengths of the driving wires.

17. The touch display device according to claim 16, wherein the driving wires comprises a first driving wire and a second driving wire, and if the length of the first driving wire is larger than the length of the second driving wire, the amplitude of a first common voltage signal provided by the driver chip is larger than the amplitude of a second common voltage signal provided by the driver chip; wherein the first common voltage signal is provided to the corresponding common electrode via the first driving wire, and the second common voltage signal is provided to the corresponding common electrode via the second driving wire.

18. The touch display device according to claim 13, wherein differences between the amplitudes of the common voltage signals after attenuation received by the different common electrodes are smaller than a set value.

19. The touch display device according to claim 13, wherein the driver chip obtains the common voltage signals with the plurality of different amplitudes from a specific storage by a look-up table manner.
